(19) United States
(12) Patent Application Publication
(10) Pub. No.: US 2005/0134081 A1
(43) Pub. Date: Jun. 23, 2005

(54) Cover for covering selected portions of a vehicle

(76) Inventor: Erhardt Bell, Medina, OH (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 10/966,045

(22) Filed: Oct. 15, 2004

Related U.S. Application Data
(60) Provisional application No. 60/511,447, filed on Oct. 15, 2003.
(60) Provisional application No. 60/574,164, filed on May 25, 2004.

(51) Int. Cl. B60J 7/20

(52) U.S. Cl. 296/136.07

(57) ABSTRACT

A protective cover for a vehicle that extends over the rear fender and across the back portion and rear fender portions of a vehicle to protect the vehicle body from stones, mud, soil and debris. The cover consists of a thin layer of material and is designed to be attached onto the body using a series of clamps and/or magnets. The protective cover is designed for use while the vehicle is in motion. A series of magnets are attached along the leading, lower, and upper edges of the cover. The cover has a series of bendable clamps that are bent in such a manner as to provide a snug, adjustable fit depending on the car model. The strap or adjoining piece of material that runs across the back of the car connects the two main sections covering the fenders. A separate flexible strap connects the two leading edges of the cover that runs along the inside of the vehicle, providing absolute security against fly-off. At least one small extension of the cover has a section of the bra covering the inside door jam. The extension includes an opening to fit over the door jam. On this section is the flexible or adjustable strap that runs along the inside of the car, preferably behind the passenger seats. The cover may further include a second flexible strap adjacent to the first flexible strap.

### CROSS-REFERENCE TO RELATED APPLICATIONS

This application claims priority from U.S. Provisional Patent Application Ser. No. 60/511,447 filed on Oct. 15, 2003, and from U.S. Provisional Patent Application Ser. No. 60/574,164 filed on May 25, 2004, which are hereby incorporated by reference.

### FIELD OF THE INVENTION

The present invention is directed to a cover for covering a selected portion of a vehicle. In particular, the present invention is directed to a cover for a vehicle that extends over at least a part of the rear portion of a vehicle.

### BACKGROUND OF THE INVENTION

Covers for selected parts of a motor vehicle have been previously utilized for portions including the front fender, hood, and bumper area including grill work and/or head lamps housing. These covers are commonly referred to as “masks” or “bras.” Such covers include one-piece and two-piece covers for covering some or all of the above mentioned areas. Traditionally, such front-end covers are made of leather or flexible plastic such as vinyl. The front-end covers are held in place with straps, tie downs, springs, grommets, clips or other apparatus, which are used to hold the covers in place.

Examples of covers for portions of a vehicle are disclosed in U.S. Pat. Nos. 5,944,347, 5,280,989, 5,209,545, 5,195,778, 5,056,817, 4,997,229, 4,953,909, 4,589,459, and 4,219,218, each of which are fully incorporated herein by reference.

Moreover, the expensive finish of luxury vehicles, such as sports cars, are vulnerable to damage by the elements and foreign objects when driving, particularly at high speeds. The need for a protective cover is greatly felt, particularly one that would not detract from the appearance of the car, would be stable at high speeds, and afford adequate protection.

As disclosed above, protective covers for automobile and other vehicles have been known for some time and are generally designed and constructed for certain specific protective features and to protect certain portions of the automobile. Two-piece covers or masks have been used for covering portions of the front fender and bumper area and separately the engine compartment hood area of an automobile. Such known covers also include covers for vehicle headlamps, housings including those which are movable between stored and operative positions. While protective and/or decorative covers have been utilized, particularly for covering the front portions of a vehicle, improvements in such covers could nevertheless be made.

### SUMMARY OF THE INVENTION

The present invention is directed to a decorative and functional vehicle covering. The covering is aesthetic in appearance so as not to detract from the overall appearance of the vehicle. The aesthetic appearance of the covering provides a vehicle with a distinctive appearance that tends to set one car apart from another and allows the owner to customize the vehicle. Also, the covering is functional in that it securely protects portions of the vehicle from damage by dirt and debris that may fall on or be thrown upon the rear fender.

In particular, the covering provides additional protection from paint damage on certain portions of the vehicle from paint or body damage caused by flying stones, chips and other airborne debris while driving. Furthermore, the covering has an attaching means that prevents theft of the covering and secures the covering to the vehicle while the vehicle is in operation. The covering is also designed for use on luxury vehicles, such as sports cars, so that the covering can protect the finish of the vehicle from damage and still not blow away when the car is operating at high speeds. Thus, when in position, the covering does not detract, and in fact enhances, the appearance of the car.

The present invention is directed to a cover for covering a portion of the rear of a vehicle. The cover can cover a least a portion of the rear fender on the driver and passenger side of the car. The cover also covers a portion of the rear top portion of the car. The cover protects those portions of the vehicle from paint or body damage while providing an attractive aesthetic appearance. The cover further includes attaching means, such as clamps and magnets that attach the cover to the vehicle to hold the cover in place. The cover further includes a strap that further attaches the cover to the vehicle.

In another aspect, the present invention is directed to a protective cover for a vehicle that extends over the rear fender and across the back to protect the vehicle body from stones, mud, soil and debris. The cover includes a thin layer of material and is designed to be clamped onto the body using a series of clamps. The protective cover is designed for use while the vehicle is in motion. A plurality of magnets is sown all along the leading, lower, and upper edges of the cover. The cover further has a plurality of bendable clamps that are bent in such a manner as to provide a snug, adjustable fit depending on the car model. The strap or adjoining piece of material that runs across the back of the car connects the two main sections covering the fenders.

A separate flexible or bunji-like strap connects the two leading edges of the cover that runs along the inside of the vehicle, providing absolute security against fly-off and further provides security against potential theft of the cover. A small extension of the cover has a section of the bra covering the inside door jam. A hole is cut out to fit over the door jam. On this section is the adjustable bunji-like cord strap that runs along the inside of the car, preferably behind the passenger seats.

Alternatively, a set of separate bunji-like straps (two straps) connect two leading edges of the cover located on the inside of the vehicle, providing absolute security against fly-off and further providing security against potential theft of the cover. A small extension of the cover has a section of the bra covering the inside door jam. A hole is cut out to fit over the door jam. On this section is a first strap that runs along the inside of the vehicle, preferably behind the passenger seats. The second strap cord is located several inches above the first strap serving the same purpose: pulling the car cover taught and into the interior of the car. This second strap runs parallel and along with the first strap.

Still other benefits and advantages of the invention will become apparent to those skilled in the art upon a reading and understanding of the following detailed description.

### BRIEF DESCRIPTION OF THE DRAWINGS

The invention may take physical form in certain parts and arrangement of parts a preferred embodiment and method of which will be described in detail in this specification and illustrated in the accompanying drawings that form a part hereof, and wherein:

FIG. 1 is a plan view of the covering of the invention in a flattened position prior to fastening to a vehicle.

FIG. 2 is a top view of the covering attached to a vehicle.

FIG. 3 is a side view of the covering covering a rear portion of a vehicle.

FIG. 4 is a partial sectional or partial schematic view of a portion of the covering attached to the rear fender well of a vehicle.

FIG. 5 shows a partial sectional or partial schematic view of an extension of the covering connected to the door latch of a vehicle.

FIG. 6 shows a partial sectional or partial schematic view of two extensions of the covering connected to the door latch of a vehicle.

### DETAILED DESCRIPTION OF THE PREFERRED EMBODIMENTS

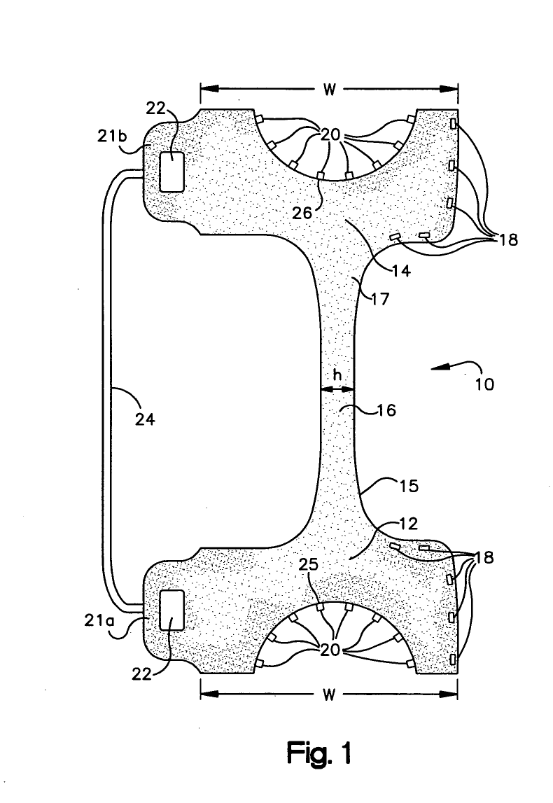

Referring now to the figures, FIG. 1 shows a covering 10. The covering 10 may be made of leather, vinyl heat resistant plastic, or of any other known covering material. Covering 10 includes a first side flap 12 and a second side flap 14. A connecting strip 16 has two sides 17 and 15 and connects first and second side flaps 12 and 14 thereto. The connecting strip 16 further has a height h. First and second side flaps 12 and 14 extend from each side 15 and 17 of the connecting strip 16. The first and second side flaps 12 and 14 each have a width w that is greater than the height h of the connecting strip 16. Further, the first and second side flaps 12 and 14 each have a wheel well cutout portion 25 and 26 therein. Finally, first and second side flaps 12 and 14 include a means of attaching the covering 10 to a vehicle. Such means of attaching the covering 10 to a vehicle include magnets 18 and clamps or hooks 20 that are attached to the covering 10 and can be releasable connected to the vehicle. Attaching means can further include strips, tie-downs, springs, grommets, clips or other apparatus. Extension 21a extending from the first flap 12 and extension 21b extending from the second flap 14 are releasably connected to the door jam located on a vehicle. The extensions 21 include an opening 22 where the door latch on the car door jam can be placed therein. A strap 24 is releasably connected to the extensions 21.

The protective cover 10 of the present invention can be readily adapted to all vehicles including sports cars, coupes, sedans, trucks, pickups, construction vehicles, boats, planes, etc. The term vehicle, as is used herein, is intended to cover all forms of vehicles, including those referenced above.

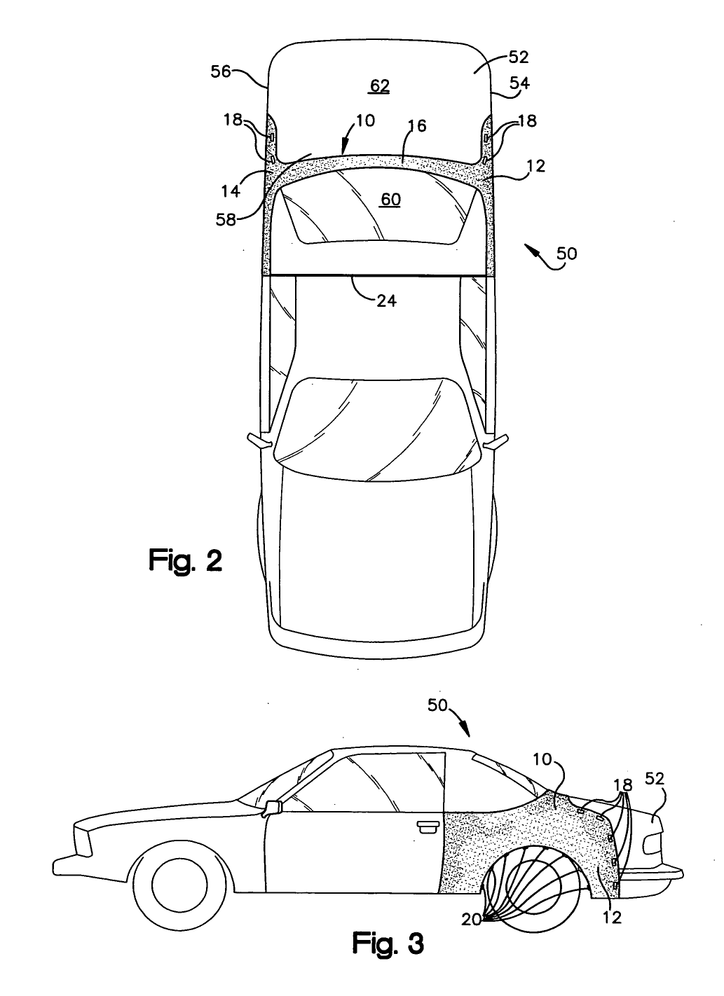

FIG. 2 shows the covering 10 attached to the rear portion of a vehicle 50, such as a sports car. The vehicle 50 has a magnetically attractive vehicle body 52. The vehicle 10 has a first rear fender side portion 54 and a second rear fender side portion 56. The vehicle 50 further includes a rear top portion 58 located between the rear window 60 and a trunk 62. First and second side flaps 12 and 14 cover a significant portion of the rear quarter panels of the vehicle. The strip 16 extends on the body of the vehicle, and more particularly, on the top of the rear portion of the vehicle behind the window. The magnets 18 releasably attach to the vehicle along the edges of the covering 10 to provide an adjustable fit onto the vehicle.

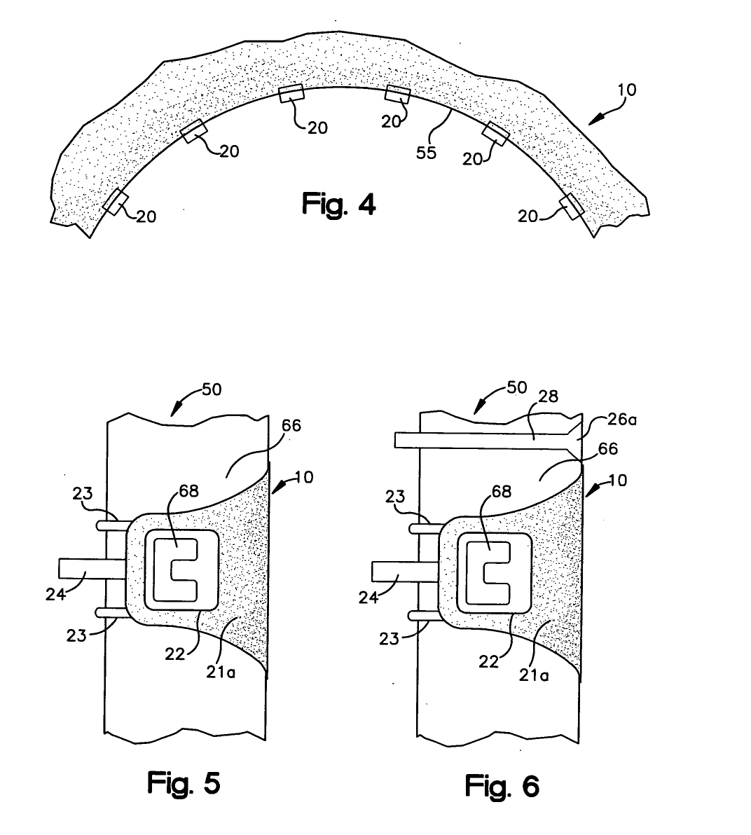

FIG. 3 further shows the attachment of the clamps 20 and magnets 18 on the covering 10 to the vehicle. The magnets that are attached to the covering 10 are releasably connected to the vehicle. The clamps 20 clamp along the wheel well of the vehicle to attach the covering 10 to the vehicle. FIG. 4 further shows the clamps 20 of the covering 10 attached to the rear fender well 55 of the vehicle 50.

FIG. 5 shows an extension 21a of the covering 10 attached to a vehicle door jam 66. As is shown in FIG. 1, extension 21b can also have the same configuration as extension 21a as shown in FIG. 5. The opening 22 of the extension 21a provides an opening for the door latch 68 so that the door of the vehicle 50 may open and close without the covering 10 prohibiting the function of the door. Extension 21 further includes strap 24 that can extend either under the bottom of the vehicle or in the interior of the vehicle to the second extension 21b. The strap 24 provides the covering 10 with security against the possibility of detaching from the vehicle 50 when the vehicle is in operation. Furthermore, the strap provides security to the covering 10 by making the covering 10 more difficult to steal from the vehicle 50. Extension 21a can further include one or more hooks 23. The hooks 23 attach to the interior molding of the vehicle 50 adjacent to the vehicle door jam 66. Thus, the hooks 23 further secure the covering 10 to the vehicle 50. It is contemplated that the covering 10 can include the hooks 23 instead of the strap 24. It is also contemplated that the covering 10 can include the strap 24 instead of the hooks 23.

FIG. 6 shows an alternate embodiment to the one shown in FIG. 5. In particular, FIG. 6 shows an additional extension 26a of the covering above extension 21a. The covering 10 in this embodiment includes a second extension 26b similar in shape of extension 26a located on the door opposite from the door which extension 26b is located. Extensions 26a and 26b include a strap 28. The strap 28 extends from extension 26a to 26b either under the bottom of the vehicle or in the interior of the vehicle. Extensions 26a and 26b and strap 28 further provide support and securement to the covering 10. Extensions 26a and 26b may also be configured to include one or more openings (not shown) similar to opening 22 on extension 21a in order to allow parts on the vehicle 50 to extend outwardly and so that the covering 10 does not interfere with such parts.

It should be evident that as installed the covering 10 possesses all of the properties previously enumerated and performs its useful function in an efficient as well as novel manner.

It has been found that the covering 10 offers complete protection to the car finish for the portion of the automobile that it covers. The covering 10 is stable at high speeds and can be readily removed when desired for cleaning or other purposes.

When installing, the covering 10 is first draped over the rear portion of the vehicle 50. The covering 10 is draped over so that the first flap 12 covers the first rear fender side portion 54 and the second flap 14 covers the second rear fender side portion 56. The connecting strip 16 rests over the rear top portion 58 located between the rear window 60 and a trunk 62. Attaching means, such as clamps 20, are attached along the first fender well 55, 57. Additional attaching means, such as magnets 18, are further attached to the first and second rear fender side portions 54, 56. Openings 22 on the extensions 21 of the first and second flaps 12, 14 are inserted over the door latch of the vehicle door jam on the driver's side door entry and the passenger's side door entry. If the covering includes the second strap 28, extensions 26a and 26b are also inserted between the door and the body of the vehicle. Strap 24 is then attached either underneath the vehicle or inside the vehicle to that the ends of the strap 24 are attached to extensions 21a and 21b. Also, strap 28, if used, is attached to extensions 26a and 26b. The clamps 20, magnets 18, and straps 24and 28 are applied in a way so that a suitable tension is applied on the covering 10 on the vehicle 50 to provide a desirable aesthetic appearance and protection. It is also preferably desirable that the material of the covering 10 exhibits at least some elastic properties to further provide a suitable tension and to provide a snug fit at all points of contact between the covering 10 and the vehicle 50.

The description above shows the invention preferably adapted to a sports car such as a Porsche, but it is evident that slight modifications will make is suitable for use with other models as well as other different makes of all vehicles including cars, trucks, and sport utility vehicles using the same principal of construction and installation of the cover.

While particular embodiments of the invention have been illustrated and described herein, it is not intended to limit the invention and changes and modifications that may be made therein within the scope of the following claims.

1. A cover for covering selected portions of a vehicle, the cover comprising:
a first flap for covering at least a portion of a first rear quarter panel of the vehicle; and
a second flap connected to the first flap, the second flap covering at least a portion of a second rear quarter panel of the vehicle.

2. The cover of claim 1, further comprising a connecting strip connecting the first flap with the second flap.

3. The cover of claim 2, further comprising a first attachment device for releasably attaching the first flap to the selected portion of the vehicle, and a second attachment device for releasably attaching the second flap to the selected portion of the vehicle.

4. The cover of claim 3, wherein the first and second flaps further comprise first and second extensions respectively.

5. The cover of claim 4, wherein the first and second extensions are releasably connected to a door jam of the vehicle.

6. The cover of claim 5, wherein the first and second extensions have openings to prevent covering a latch on the door jam.

7. The cover of claim 6, wherein a strap is releasably connected to the first and second extensions, wherein the strap extends within an interior of the vehicle.

8. The cover of claim 7, wherein the first and second flaps further comprise third and fourth extensions respectively.

9. The cover of claim 8, wherein a second strap is releasably connected to the third and fourth extensions, wherein the second strap extends within the interior of the vehicle.

10. The cover of claim 3, wherein the first attachment device comprises at least one of strips, tie downs, springs, grommets, hooks, clips, and magnets and the second attachment device comprises at least one of strips, tie downs, springs, grommets, hooks, clips, and magnets.

11. A cover for covering selected portions of a vehicle having a body and having first and second rear quarter panels, the cover comprising:
a first flap for covering at least a portion of the first rear quarter panel of the vehicle;
a second flap for covering at least a portion of the second rear quarter panel of the vehicle;
a connecting strip connecting the first flap to the second flap, the connecting strip extending over the body of the vehicle;
a first attachment device for releasably attaching the first flap to the first rear quarter panel of the vehicle; and
a second attachment device for releasably attaching the second flap to the second rear quarter panel of the vehicle.

13. The cover of claim 12, wherein the first and second flaps further comprise first and second extensions respectively.

14. The cover of claim 13, wherein the first and second flaps further comprise a wheel well cutout.

15. The cover of claim 14, wherein the first attachment device comprises at least one of strips, tie downs, springs, grommets, hooks, clips, and magnets and the second attachment device comprises at east one of strips, tie downs, springs, grommets, hooks, clips, and magnets.

16. The cover of claim 15, wherein the vehicle further comprises a rear window and a trunk, the connecting strip extending between the rear window and trunk of the vehicle.

17. A cover for covering selected portions of a vehicle, the cover comprising:
a connecting strip having two sides and having a height; and
a flap extending from each side of the connecting strip, wherein the flaps each have a width that is greater than the height of the connecting strip, and wherein each flap has a wheel well cutout portion therein.

18. The cover of claim 17, wherein the vehicle further comprises first and second rear quarter panels.

19. The cover of claim 18, wherein the flaps cover a portion of the first and second rear quarter panels of the vehicle.
